(19) United States
(12) Patent Application Publication
(10) Pub. No.: US 2007/0075926 A1
(43) Pub. Date: Apr. 5, 2007

(54) APPARATUS AND METHOD FOR DRIVING PLASMA DISPLAY PANEL

(76) Inventors: Hai Young JUNG, Incheon (KR); Byung Nam Ahn, Seoul (KR)

Correspondence Address: FLESHNER & KIM, LLP, P.O. BOX 221200, CHANTILLY, VA, 20153, US

(21) Appl. No.: 11/536,793

(22) Filed: Sep. 29, 2006

(30) Foreign Application Priority Data
Oct. 5, 2005 (KR) 10-2005-0093343

(51) Int. Cl. G09G 3/28

(52) U.S. Cl. 345/63

(57) ABSTRACT

An apparatus and method for driving a plasma display panel is disclosed. The apparatus includes a level shifting unit for gradually changing a bias level of the scan bias voltage, and a scan driving unit for sequentially applying the scan bias voltage having the changed bias level to the scan electrodes.

This application claims the benefit of Korean Patent Application No. 10-2005-0093343, filed on Oct. 05, 2005, which is hereby incorporated by reference as if fully set forth herein.

### BACKGROUND OF THE INVENTION

1. Field of the Invention

The present invention relates to a plasma display panel (hereinafter, referred to as a PDP), and more particularly, to an apparatus and method for driving a PDP by generating and supplying a scan-up signal and a scan-down signal to scan electrodes.

2. Discussion of the Related Art

A conventional alternating current type surface discharge PDP is time-divisionally driven with one frame being divided into a plurality of sub-fields having a different frequency of emission in order to implement a gray scale of an image. Each sub-field includes a reset period for initializing an entire screen, an address period for selecting a scan line and selecting a cell in the selected scan line, and a sustain period for implementing a gray scale depending on the frequency of discharging.

FIG. 1 is a waveform diagram illustrating driving waveforms supplied to two sub-fields, that is, a signal Y supplied to scan electrodes, a signal Z supplied to sustain electrodes and a signal X supplied to address electrodes.

Referring to FIG. 1, each sub-field includes a reset period, an address period and a sustain period. In a set-up period of the reset period, a ramp-up waveform Ramp-up is simultaneously applied to all the scan electrodes Y. In a set-down period, a ramp-down waveform Ramp-down whose voltage falls from a positive voltage lower than a peak voltage of the ramp-up waveform is simultaneously applied to the scan electrodes Y.

In the address period, a scan pulse Scan of the negative polarity is sequentially applied to the scan electrodes Y and simultaneously a data pulse data of the positive polarity is applied to the address electrodes X. As a voltage difference between the scan pulse and the data pulse and a wall voltage generated in the reset period are added, an address discharge occurs in on-cells to which the data pulse is supplied.

In the sustain period, a sustain pulse sus is alternately applied to the scan electrodes Y and the sustain electrodes Z.

In a conventional PDP driving method shown in FIG. 1, discharging characteristics of the PDP are affected by operating characteristics of the address period. In a conventional address and display separation (ADS) driving scheme, when the state of wall charge is not suitable for addressing after the reset operation, the address discharge becomes unstable and the sustain operation is not normally performed. More particularly, at the end of the address period, the wall charge formed in the reset period may be lost, and priming effect may deteriorate compared with a previous line and accordingly a wrong discharge may occur.

FIG. 2 is a view showing a distribution of wall charge on a closed curve of transfer voltage Vt immediately after the set-down.

Referring to FIG. 2, after the set-down operation, the wall charge is distributed at a point 10 on the Vt curve. However, when the distribution of the wall charge is reduced by a scanning operation, the distribution of the wall charge is moved by an arrow 12. When voltages Vy and Vz are applied in this state, the voltages do not exceed a threshold value of the Vt curve, an address discharge becomes unstable, and a wrong discharge phenomenon occurs.

### SUMMARY OF THE INVENTION

Accordingly, the present invention is directed to an apparatus and method for driving a plasma display panel that substantially obviates one or more problems due to limitations and disadvantages of the related art.

An object of the present invention is to provide an apparatus and method for driving a plasma display panel which improves address discharge characteristics by changing the level of a scan bias voltage in an address period.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for driving a plasma display panel includes a level shifting unit for gradually changing a bias level of the scan bias voltage and a scan driving unit for sequentially applying the scan bias voltage having the changed bias level to the scan electrodes.

The level shifting unit may gradually decrease or increase the bias level in a second half of the address period, without changing the bias level in a first half of the address period.

The level shifting unit may gradually decrease or increase the bias level from a first half to a second half of the address period.

The level shifting unit may include a triangle wave generating unit for generating a triangle wave in response to a scan synchronization signal generated during the address period, a level detecting unit for detecting the level of the generated triangle wave, and a voltage generating unit for generating the scan bias voltage having the bias level corresponding to the detected level.

The level detecting unit may include a first resistor electrically connected to the triangle wave generating unit, a second resistor electrically connected between a node between the first resistor and the triangle wave generating unit and a reference voltage, a first transistor having a base electrically connected to the first resistor, and a third resistor connected between an emitter and a collector of the first transistor.

The voltage generating unit may include a fourth resistor electrically connected to the level detecting unit, a fifth resistor electrically connected between the fourth resistor and a scan bias voltage terminal for applying the scan bias voltage, a shunt regulator having a reference terminal connected to a node between the fourth and fifth resistors and cathode and anode terminals electrically connected between the scan bias voltage terminal and the reference voltage terminal, and a feedback unit provided between the cathode terminal of the shunt regulator and the scan bias voltage terminal, for supplying a sustain voltage in response to the level of the scan bias voltage as an input voltage of the shunt regulator.

The feedback unit may include a light emitting unit connected between the cathode terminal and the scan bias voltage terminal, for generating light corresponding to the detected level, a light receiving unit for converting the generated light into an electric signal, a comparing unit for comparing the electric signal with the triangle wave of the triangle wave generating unit and outputting a result of the comparison, a switch connected between a sustain voltage terminal for applying the sustain voltage and the scan bias voltage terminal and turned on in response to the result of the comparison outputted from the comparing unit, and an inductor connected between the switch and the scan bias voltage terminal.

The feedback unit may include a light emitting unit connected between the cathode terminal and the scan bias voltage terminal, for generating light corresponding to the detected level, a light receiving unit for converting the generated light into an electric signal, a comparing unit for comparing the electric signal with the triangle wave of the triangle wave generating unit and outputting a result of the comparison, a transformer having a secondary side connected to the light emitting unit, a switch connected between a negative side of the sustain voltage terminal and a primary side of the transformer and turned on in response to the result of the comparison outputted from the comparing unit, and a diode having an anode and a cathode, which are connected to the secondary side of the transformer and the scan bias voltage terminal, respectively.

In another aspect of the present invention, a method for driving a plasma display panel includes gradually changing a bias level of the scan bias voltage, and sequentially applying the scan bias voltage having the changed bias level to the scan electrodes.

The changing step may include generating a triangle wave in response to a scan synchronization signal generated during an address period, detecting a level of the generated triangle wave, and generating the scan bias voltage having the bias level corresponding to the detected level.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a waveform view showing driving waveforms of a general PDP.

FIG. 2 is a view showing a distribution of wall charge on a closed curve of transfer voltage immediately after set-down of FIG. 1.

FIG. 3 is a block diagram showing the configuration of an apparatus for driving a plasma display panel (PDP) according to the present invention.

FIG. 4 is a waveform view showing waveforms generated by the apparatus for driving the PDP according to the present invention.

FIG. 5 is a block diagram showing a preferred embodiment of a level shifting unit shown in FIG. 3.

FIG. 6 is a circuit diagram showing an embodiment of a level shifting unit shown in FIG. 5.

FIG. 7 is a circuit diagram showing an embodiment of a feedback unit shown in FIG. 6.

FIGS. 8a and 8b are waveform diagrams illustrating the operation of a comparing unit shown in FIG. 7.

FIG. 9 is a circuit diagram showing another embodiment of the feedback unit shown in FIG. 6.

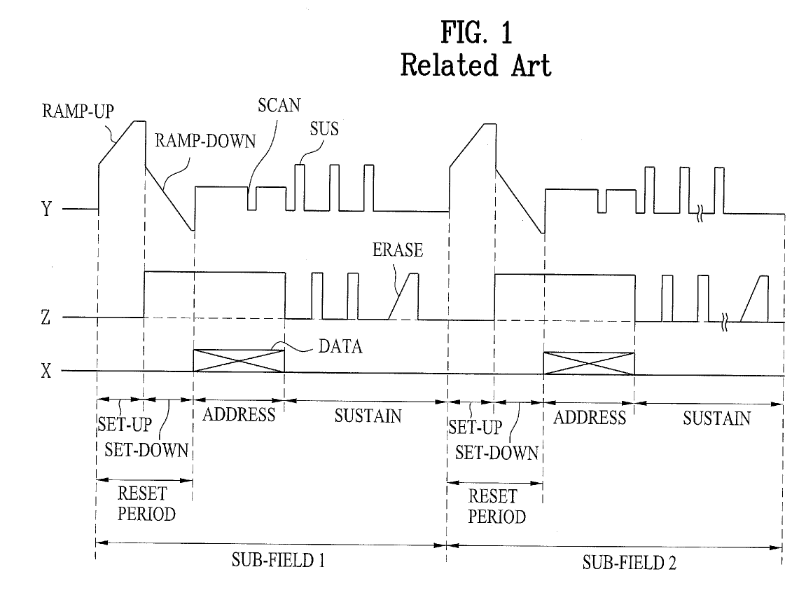

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, the configuration and the operation of an apparatus and method for driving a plasma display panel (PDP) will be described with reference to the attached drawings.

FIG. 3 is a block diagram showing the configuration of the apparatus for driving the PDP according to the present invention, which includes a level shifting unit 20 and a scan driving unit 22.

The level shifting unit 20 shown in FIG. 3 changes a scan bias voltage Vy to have a gradient bias level in an address period. The level shifting unit 20 generates the scan bias voltage Vy having the gradient bias level from a sustain voltage Vs inputted through an input terminal IN1.

According to an embodiment of the present invention, the level shifting unit 20 may change the bias level of the scan bias voltage over the whole address period. Alternatively, according to another embodiment of the present invention, the level shifting unit 20 may gradually change the bias level of the scan bias voltage in a second half of the address period, without changing the bias level of the scan bias voltage in a first half of the address period.

The level shifting unit 20 may gradually increase or decrease the bias level of the scan bias voltage in the address period.

The scan driving unit 22 shown in FIG. 3 sequentially applies the scan bias voltage having the bias level shifted in the level shifting unit 20 to scan electrodes as a scan-down voltage in the address period. According to the present invention, the scan driving unit 22 may perform scanning using a dual scan method or a single scan method.

Hereinafter, in order to facilitate understanding of the present invention, as an example, when the level shifting unit 20 gradually decreases the bias level of the scan bias voltage, the configuration and the operation of the apparatus for driving the PDP shown in FIG. 3 will be described with reference to the attached drawings.

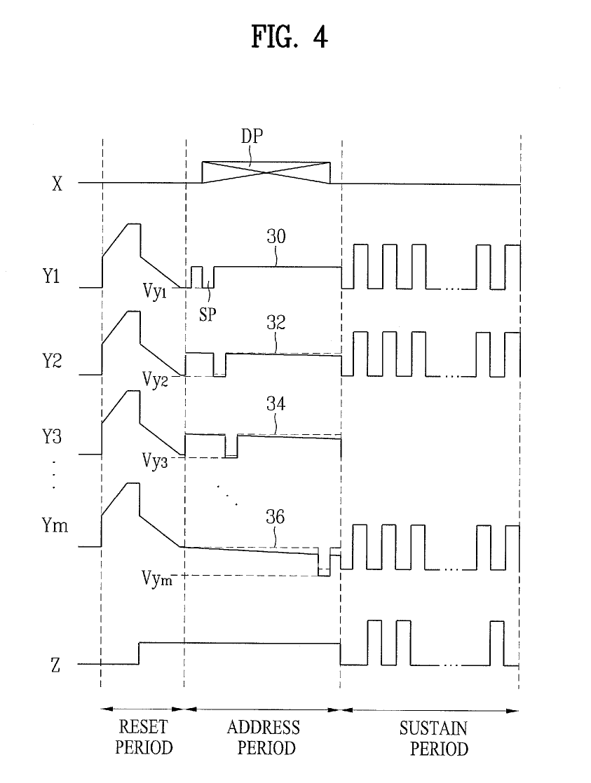

FIG. 4 is a waveform view showing waveforms generated by the apparatus for driving the PDP according to the present invention, that is, a signal X supplied to address electrodes, signals Y₁, Y₂, Y₃, . . . and Yₘ supplied to the scan electrodes and a signal Z supplied to sustain electrodes. Reference numerals 30, 32, 34, . . . and 36 denote scan-up voltages generated by a conventional PDP driving method and have the same bias level.

Referring to FIG. 4, in the apparatus for driving the PDP according to the present invention, an entire screen is initiated in a reset period of one sub-field, data DP is written in an address period while the entire screen is scanned in the address period, and emission states of cells in which the data is written are maintained in a sustain period.

The level shifting unit 20 shown in FIG. 3 gradually decreases the bias levels of the scan bias voltages V_{y1}, V_{y2}, V_{y3}, . . . and V_{ym} from a first half to a second half of the address period, as shown in FIG. 4. Then, the scan driving unit 22 sequentially supplies the scan bias voltages V_{y1}, V_{y2}, V_{y3}, . . . and V_{ym} having the gradually decreasing bias level to the scan electrodes Y₁, Y₂, Y₃, . . . and Yₘ, as a scan-down voltage SP.

Meanwhile, when the level shifting unit 20 gradually changes the bias level of the scan bias voltage in the second half of the address period without changing the bias level of the scan bias voltage in the first period of the address period, the levels of the scan-down voltages V_{y1}, . . . and V_{ym/2} supplied to the scan electrodes Y₁ to Y_{m/2} are the same, but the levels of the scan-down voltages V_{y(m/2+1)}, . . . and V_{ym} supplied to the scan electrodes Y_{m/2+1} to Yₘ gradually increase or decrease.

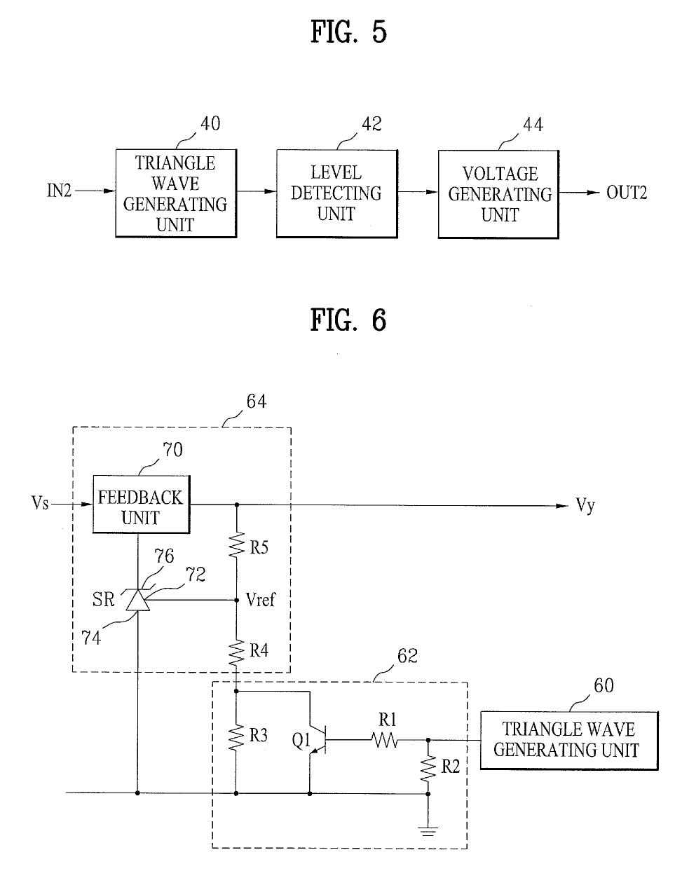

FIG. 5 is a block diagram showing a preferred embodiment of the level shifting unit 20 shown in FIG. 3. The level shifting unit 20 includes a triangle wave generating unit 40, a level detecting unit 42, a voltage generating unit 44.

The triangle generating unit 40 of the level shifting unit 42 shown in FIG. 5 generates a triangle wave in response to a scan synchronization signal inputted through an input terminal IN2 during the address period and outputs the generated triangle wave to the level detecting unit 42. The scan bias voltage Vy used for generating the scan-down voltage may be used for generating a set-down voltage in the reset period. In this case, the bias level of the scan bias voltage must be changed. That is, the bias level of the scan bias voltage must be changed only in the address period. Accordingly, the triangle wave generating unit 40 generates the triangle wave only in the address period in response to the scan synchronization signal. At this time, when the bias level of the scan bias voltage is desired to be changed in the second half of the address period without changing the bias level of the scan bias voltage in the first half of the address period, the triangle wave may be generated only in the second half of the address period using the scan synchronization signal. Suppose that the triangle wave generating unit 40 generates the triangle wave in response to the scan synchronization signal having a logic level “High”. The scan synchronization signal has a logic level “Low” in the first half of the address period and a logic level “High” in the second half of the address period.

The level detecting unit 42 detects the level of the triangle wave generated in the triangle wave generating unit 40 and outputs the detected level to the voltage generating unit 44.

The voltage generating unit 44 generates the scan bias voltage Vy having the bias level corresponding to the level detected in the level detecting unit 42. The voltage generating unit 44 may generate the scan bias voltage Vy having the level which gradually increases or decreases as the level of the triangle wave gradually increases or decreases.

FIG. 6 is a circuit diagram showing an embodiment of the level shifting unit 20 shown in FIG. 5. The level shifting unit 20 includes a triangle wave generating unit 60, a level detecting unit 62 and a voltage generating unit 64.

The triangle wave generating unit 60, the level detecting unit 62 and the voltage generating unit 64 shown in FIG. 6 perform the same functions as those of the triangle wave generating unit 40, the level detecting unit 42 and the voltage generating unit 44 shown in FIG. 5, respectively.

According to the present invention, the level detecting unit 62 may include resistors R1, R2 and R3 and a transistor Q1, as shown in FIG. 6. One side of the first resistor R1 is connected to the triangle wave generating unit 60 and the second resistor R2 is connected between the triangle wave generating unit 60 and a reference voltage terminal. The first transistor Q1 has a base connected to the other side of the first resistor R1 and the third resistor R3 is connected between a collector and an emitter of the first transistor Q1. In such a configuration, the level detected in the level detecting unit 62 corresponds to a voltage across the third resistor R3.

The voltage generating unit 64 may include a shunt regulator SR, fourth and fifth resistors R4 and R5 and a feedback unit 70. The shunt regulator SR has a reference terminal 72 and cathode and anode terminals 76 and 74 which are connected to a scan bias voltage terminal Vy and the reference voltage terminal, respectively. The reference terminal 72 of the shunt regulator SR corresponds to an input terminal of a comparing unit (not shown) mounted in the shunt regulator SR. The fourth resistor R4 is connected between the third resistor R3 and the reference terminal 72 of the shunt regulator SR and the fifth resistor R5 is provided between the reference terminal 72 and the scan bias voltage terminal Vy. The feedback unit 70 is provided between the cathode terminal 76 of the shunt regulator SR and the scan bias voltage terminal Vy and supplies a sustain voltage as an input voltage of the shunt regulator SR in response to the level of the scan bias voltage Vy.

In the configuration shown in FIG. 6, since the amount of current flowing in the base of the transistor Q1 is changed depending on the voltage of the triangle wave, a resistance value RQce between the emitter and the collector of the transistor Q1 varies. The resistance value RQce increases or decreases over time depending on the voltage of the triangle wave. For example, the scan bias voltage Vy generated in the voltage generating unit 64 is expressed by Equation 1.

$${V}_{y} = {V}_{ref} \times ( 1 + \frac{R 5}{R 4 + ( R 3 // RQce )} ) \qquad Equation 1$$

where, Vref denotes an internal reference voltage of the shunt regulator SR.

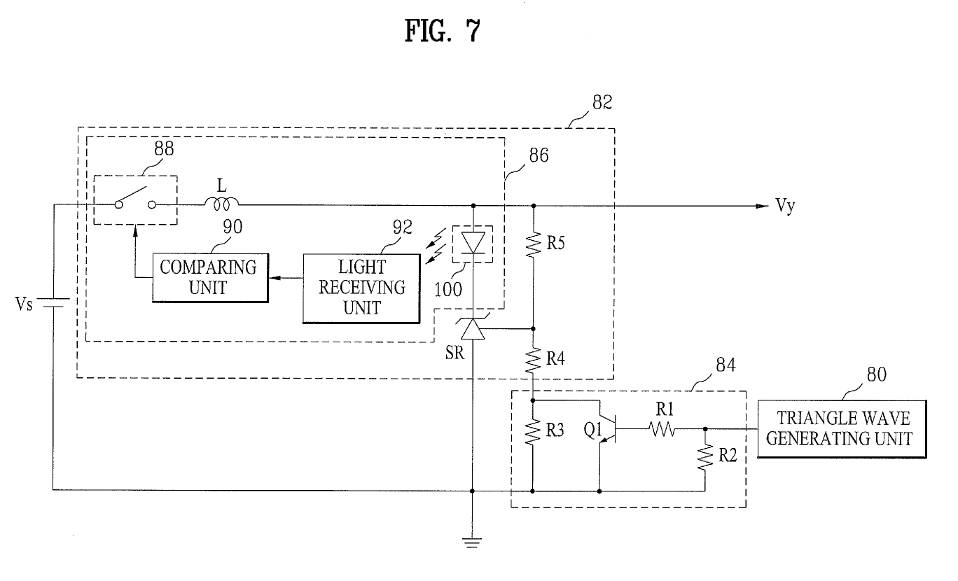

FIG. 7 is a circuit diagram showing an embodiment of the feedback unit 70 shown in FIG. 6.

The level detecting unit 84 shown in FIG. 7 has the same configuration and function as those of the level detecting unit 62 shown in FIG. 6 and thus their detailed description will be omitted.

The voltage generating unit 82 shown in FIG. 7 includes a shunt regulator SR, fourth and fifth resistors R4 and R5 and a feedback unit 86. The shunt regulator SR and the fourth and fifth resistors R4 and R5 have the same functions as those of the shunt regulator SR and the fourth and fifth resistors R4 and R5 shown in FIG. 6, respectively, and thus their detailed description will be omitted.

The feedback unit 86 has the same function as that of the feedback unit 70. As shown in FIG. 7, the feedback unit 86 may include a switch 88, an inductor L, a comparing unit 90, a light receiving unit 92 and a light emitting unit 100. The light emitting unit 100 is connected between the cathode terminal of the shunt regulator SR and the scan bias voltage terminal Vy and generates light corresponding to the level detected in the level detecting unit 84. The light receiving unit 92 receives the light emitted from the light emitting unit 100, converts the received light into an electric signal, and outputs the converted electric signal to the comparing unit 90.

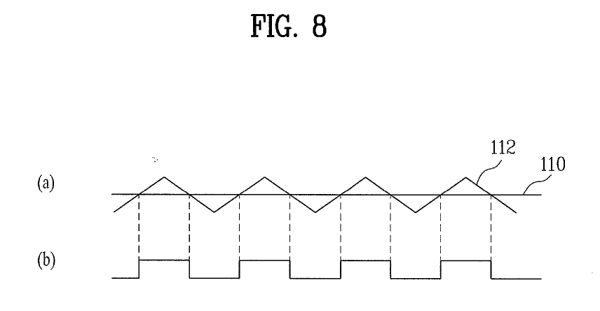

FIGS. 8a and 8b are waveform diagrams illustrating the operation of the comparing unit 90 shown in FIG. 7.

The comparing unit 90 compares the electric signal outputted from the light receiving unit 92 with the triangle wave and outputs the result of the comparison as a control signal of the switch 88. That is, the comparing unit 90 compares the electric signal 110 outputted from the light receiving unit 92 with the triangle wave 112 and outputs a signal having a rectangle waveform shown in FIG. 8b, which is the result of the comparison, to the switch 88 as the control signal of the switch 88.

The switch 88 is connected between a sustain voltage terminal Vs and the scan bias voltage terminal Vy and is turned on in response to the result of the comparison outputted from the comparing unit 90. In the feedback unit 86, an inductor L may be further provided between the switch 88 and the scan bias voltage terminal Vy.

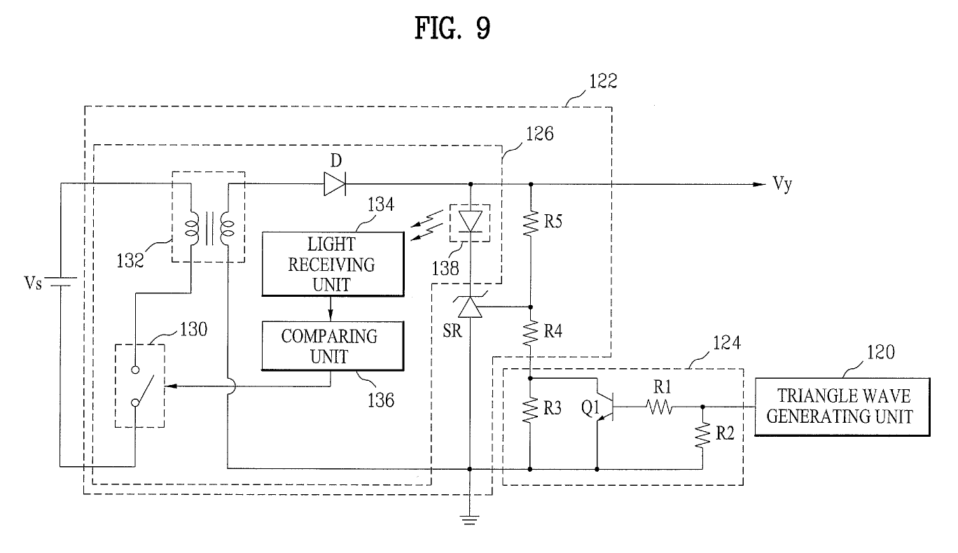

FIG. 9 is a circuit diagram showing another embodiment of the feedback unit 70 shown in FIG. 6.

The level detecting unit 124 shown in FIG. 9 has the same configuration and function as those of the level detecting unit 62 shown in FIG. 6 and thus their detailed description will be omitted.

The voltage generating unit 122 shown in FIG. 9 may include a shunt regulator SR, fourth and fifth resistors R4 and R5 and a feedback unit 126. The shunt regulator SR and the fourth and fifth resistors R4 and R5 have the same functions as those of the shunt regulator SR and the fourth and fifth resistors R4 and R5 shown in FIG. 6, respectively, and thus their detailed description will be omitted.

The feedback unit 126 has the same function as that of the feedback unit 70. As shown in FIG. 9, the feedback unit 126 may include a switch 130, a transformer 132, a comparing unit 136, a light receiving unit 134 and a light emitting unit 138. The light emitting unit 138 is connected between the cathode terminal of the shunt regulator SR and the scan bias voltage terminal Vy and generates light corresponding to the level detected in the level detecting unit 124. The light receiving unit 134 receives the light emitted from the light emitting unit 138, converts the received light into an electric signal, and outputs the converted electric signal to the comparing unit 136.

The comparing unit 136 compares the electric signal outputted from the light receiving unit 134 with the triangle wave and outputs the result of the comparison as a control signal of the switch 130. The transformer 132 has a secondary side connected to the light emitting unit 138 and the switch 130 is connected between a negative side of the sustain voltage terminal Vs and a primary side of the transformer 132 and is turned on in response to the result of the comparison outputted from the comparing unit 136. In the feedback unit 126, a diode D having an anode and a cathode, which are respectively connected to the secondary side of the transformer 132 and the scan bias voltage terminal Vy, may be provided.

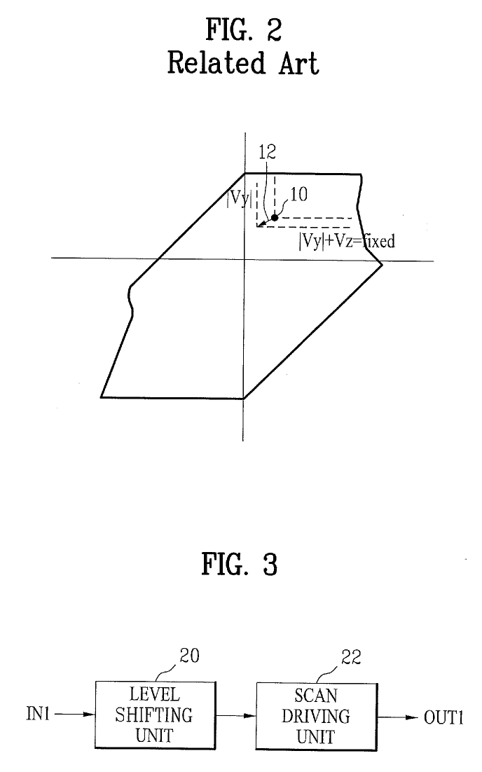

As described above, in the apparatus and method for driving the PDP according to the present invention, since the level of the scan bias voltage gradually increases or decreases in a range that a wrong discharge does not occur as an address period is finished, although the distribution of the wall charge is changed as shown in FIG. 2, the scan-down voltage is compensated by a variation amount indicated by the arrow. Accordingly, it is possible to improve address discharge characteristics at a point of time when the address period is finished, to improve set discharge characteristics, and to increase reliability. Since the level of the scan bias voltage can be easily changed only in the address period using the triangle wave and the scan synchronization signal, it is possible to reduce circuit implementation cost, to perform an address operation at a high speed, and to improve jitter characteristics.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for driving a plasma display panel by applying a scan bias voltage to scan electrodes, the apparatus comprising:
a level shifting unit for gradually changing a bias level of the scan bias voltage; and
a scan driving unit for sequentially applying the scan bias voltage having the changed bias level to the scan electrodes.

2. The apparatus according to claim 1, wherein the level shifting unit changes the bias level in an address period.

3. The apparatus according to claim 1, wherein the level shifting unit gradually decreases the bias level in a second half of the address period, without changing the bias level in a first half of the address period.

4. The apparatus according to claim 1, wherein the level shifting unit gradually increases the bias level in a second half of the address period, without changing the bias level in a first half of the address period.

5. The apparatus according to claim 1, wherein the level shifting unit gradually decreases the bias level from a first half to a second half of the address period.

6. The apparatus according to claim 1, wherein the level shifting unit gradually increases the bias level from a first half to a second half of the address period.

7. The apparatus according to claim 1, wherein the scan driving unit performs scanning using a dual scan method.

8. The apparatus according to claim 1, wherein the scan driving unit performs scanning using a single scan method.

9. The apparatus according to claim 1, wherein the level shifting unit comprises:
a triangle wave generating unit for generating a triangle wave in response to a scan synchronization signal generated during the address period;
a level detecting unit for detecting the level of the generated triangle wave; and
a voltage generating unit for generating the scan bias voltage having the bias level corresponding to the detected level.

10. The apparatus according to claim 9, wherein the level detecting unit comprises:
a first resistor electrically connected to the triangle wave generating unit;
a second resistor electrically connected between a node between the first resistor and the triangle wave generating unit and a reference voltage terminal;
a first transistor having a base electrically connected to the first resistor; and
a third resistor connected between an emitter and a collector of the first transistor.

11. The apparatus according to claim 10, wherein the level detected in the level detecting unit is a voltage across the third resistor.

12. The apparatus according to claim 9, wherein the voltage generating unit comprises:
a fourth resistor electrically connected to the level detecting unit;
a fifth resistor electrically connected between the fourth resistor and a scan bias voltage terminal for applying the scan bias voltage;
a shunt regulator having a reference terminal connected to a node between the fourth and fifth resistors and cathode and anode terminals electrically connected between the scan bias voltage terminal and the reference voltage terminal; and
a feedback unit provided between the cathode terminal of the shunt regulator and the scan bias voltage terminal, for supplying a sustain voltage in response to the level of the scan bias voltage as an input voltage of the shunt regulator.

13. The apparatus according to claim 12, wherein the feedback unit comprises:
a light emitting unit connected between the cathode terminal and the scan bias voltage terminal, for generating light corresponding to the detected level;
a light receiving unit for converting the generated light into an electric signal;
a comparing unit for comparing the electric signal with the triangle wave of the triangle wave generating unit and outputting a result of the comparison;
a switch connected between a sustain voltage terminal for applying the sustain voltage and the scan bias voltage terminal and turned on in response to the result of the comparison outputted from the comparing unit; and
an inductor connected between the switch and the scan bias voltage terminal.

14. The apparatus according to claim 12, wherein the feedback unit comprises:
a light emitting unit connected between the cathode terminal and the scan bias voltage terminal, for generating light corresponding to the detected level;
a light receiving unit for converting the generated light into an electric signal;
a comparing unit for comparing the electric signal with the triangle wave of the triangle wave generating unit and outputting a result of the comparison;
a transformer having a secondary side connected to the light emitting unit;
a switch connected between a negative side of the sustain voltage terminal and a primary side of the transformer and turned on in response to the result of the comparison outputted from the comparing unit; and
a diode having an anode and a cathode, which are connected to the secondary side of the transformer and the scan bias voltage terminal, respectively.

15. A method for driving a plasma display panel by applying a scan bias voltage to scan electrodes, the method comprising:
gradually changing a bias level of the scan bias voltage; and
sequentially applying the scan bias voltage having the changed bias level to the scan electrodes.

16. The method according to claim 15, wherein the changing step comprises:
generating a triangle wave in response to a scan synchronization signal generated during an address period;
detecting a level of the generated triangle wave; and
generating the scan bias voltage having the bias level corresponding to the detected level.
